(19) United States
(12) Patent Application Publication
(10) Pub. No.: US 2011/0007911 A1
(43) Pub. Date: Jan. 13, 2011

(54) METHODS FOR LOCATING EITHER AT LEAST ONE SOUND GENERATING OBJECT OR A MICROPHONE USING AUDIO PULSES

(75) Inventors: Jun XU, Singapore (SG); Boon Swee Low, Singapore (SG); Huayun Zhang, Singapore (SG); Yew Teng Too, Singapore (SG); Teck Chee Lee, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd., Singapore (SG)

(21) Appl. No.: 12/501,193

(22) Filed: Jul. 10, 2009

(51) Int. Cl. H04R 3/00

(52) U.S. Cl. 381/92

(57) ABSTRACT

In a first aspect, there is provided a method for locating a position of at least one sound generating object using at least one audio pulse, with the at least one audio pulse being detected by a plurality of stationary microphones located at a first position being spaced apart by a pre-determined distance. In a second aspect, there is provided a method for locating a position of a microphone using audio pulses emitted from a plurality of sound generating objects. The at least one audio pulse may preferably be in a form of a logarithmic swept sine (LSS) signal, as the LSS signal is detectable at both low volumes and amidst background noises.

### FIELD OF INVENTION

This invention relates to a field of audio transmission, specifically relating to methods for locating either at least one sound generating object or a microphone to aid in optimizing audio transmission for a user in any particular location.

### BACKGROUND

When a user is listening to audio output comprising multiple channels of audio signals, it is preferable for the user to be positioned in a central and symmetric position surrounded by a plurality of speakers so as to properly experience the multiple channels of audio signals of the audio output. However, a myriad of factors and reasons such as, for example, room shape, furniture placement, interior design aesthetic considerations, and so forth usually lead to instances of an asymmetric speaker environment and/or the user location is asymmetric relative to the plurality of speakers. These instances unfortunately lead to inter-channel differences in sound path lengths which discernibly hamper the user experience when consuming the multiple channels of audio signals of the audio output.

There are several sound processing techniques currently available to address the problem of inter-channel differences in sound path lengths so as to optimize any particular asymmetric listening location. Some of the techniques include, for example, use of balance control to correct loudness imbalance, variation of EQ settings independently in each channel, introduction of time delays in an audio channel having a shorter acoustic path and so forth.

Unfortunately, applying the aforementioned techniques when configuring speaker systems for a perceived optimised user listening experience at any particular location is typically inconvenient and time-consuming. Furthermore, the aforementioned techniques need to be applied repeatedly subsequent to any change in either the particular location or placement locations of the plurality of speakers, further exacerbating the inconvenience to the user.

In view of the aforementioned, there is clearly a problem relating to a lack of a convenient solution to enable audio output optimisation of multi-speaker set-ups for particular listening locations. The methods disclosed in the present application aim to facilitate aspects which are usable for the provision of a solution to the aforementioned problem.

### SUMMARY

In a first aspect, there is provided a method for locating a position of at least one sound generating object using at least one audio pulse, with the at least one audio pulse being detected by a plurality of stationary microphones located at a first position being spaced apart by a pre-determined distance. The pre-determined distance may preferably be at least ten centimetres so that the stationary microphones are able to distinguished and not considered a single microphone. The at least one audio pulse may preferably be in a form of a logarithmic swept sine (LSS) signal, as the LSS signal is detectable at both low volumes and amidst background noises.

The method includes generating the at least one audio pulse from the at least one sound generating object located at a second position; detecting the at least one audio pulse at each of the plurality of stationary microphones; determining a straight-line distance from the at least one sound generating object to each of the plurality of stationary microphones; determining a generalised bearing of the at least one sound generating object in relation to each of the plurality of stationary microphones; and obtaining a grid-based location of the at least one sound generating object. It is preferable that the grid-based location is obtained by determining a first intersection position of a plurality of arcs, each of the plurality of arcs being centred at each of the plurality of stationary microphones, with respective radii of each of the plurality of arcs being a respective straight-line distance from each of the plurality of stationary microphones to the at least one sound generating object. The method may be carried out by a data processing apparatus.

It is preferable that a second intersection position of the plurality of arcs is disregarded in view of the generalised bearing of the at least one sound generating object.

The straight-line distance from the at least one sound generating object to each of the plurality of stationary microphones may be determined by multiplying the speed of sound with a time difference between an audio pulse reception time at each of the plurality of stationary microphones and an audio pulse transmission time from the at least one sound generating object. The sound generating object may be either a single speaker driver or a standalone speaker.

Preferably, the generalised bearing may provide an approximation of a direction of the at least one sound generating object with reference to the plurality of stationary microphones. The plurality of stationary microphones may be incorporated in a single apparatus. It is advantageous that incorporating the plurality of stationary microphones in a single apparatus overcomes a need to use a separate set of microphones.

The grid-based location may be based on a set of arbitrary reference axes. The grid-based location may be in a form of coordinates referencing the arbitrary reference axes.

In a second aspect, there is provided a method for locating a position of a microphone using audio pulses emitted from a plurality of sound generating objects. The plurality of sound generating objects may be spaced apart by a pre-determined distance with the plurality of sound generating objects being located at a third position. The pre-determined distance may be at least ten centimetres so that the sound generating objects are able to distinguished and not considered a single sound generating object. The microphone may be coupled to a portable handheld device. It is advantageous that coupling the microphone to the portable handheld device overcomes a need to use a separate microphone. The audio pulses may be in a form of a logarithmic swept sine (LSS) signal, with the LSS signal being detectable at both low volumes and amidst background noises. The method may preferably be carried out by a data processing apparatus.

The plurality of sound generating objects may be incorporated in a single apparatus, with the sound generating object being either a single speaker driver or a standalone speaker.

The method includes generating a first audio pulse from a first sound generating object of the plurality of sound generating objects; detecting the first audio pulse at the microphone; determining a straight-line distance from the first sound generating object to the microphone; generating a second audio pulse from a second sound generating object of the plurality of sound generating objects; detecting the second audio pulse at the microphone; determining a straight-line distance from the second sound generating object to the microphone; determining a generalised bearing of each of the plurality of sound generating objects in relation to the microphone; and obtaining a grid-based location of the microphone. It is preferable that the grid-based location is obtained by determining a third intersection position of a plurality of arcs, each of the plurality of arcs being centred at each of the plurality of sound generating objects, with respective radii of each of the plurality of arcs being a respective straight-line distance from each of the plurality of sound generating objects to the microphone.

It is preferable that a fourth intersection position of the plurality of arcs is disregarded in view of the generalised bearing of the plurality of sound generating objects as the generalised bearing provides an approximation of a direction of the plurality of sound generating objects with reference to the microphone.

The straight-line distance from the plurality of sound generating objects to the microphone may be determined by multiplying the speed of sound with a time difference between an audio pulse reception time at the microphone and an audio pulse transmission time from each of the plurality of sound generating objects.

The grid-based location may be based on a set of arbitrary reference axes, with the grid-based location being in a form of coordinates referencing the arbitrary reference axes.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows an illustration of a first method of the present invention.

FIG. 2 shows a process flow of the first method of FIG. 1.

FIG. 3 shows an illustration of a second method of the present invention.

FIG. 4 shows a process flow of the second method of FIG. 3.

### DESCRIPTION OF PREFERRED EMBODIMENTS

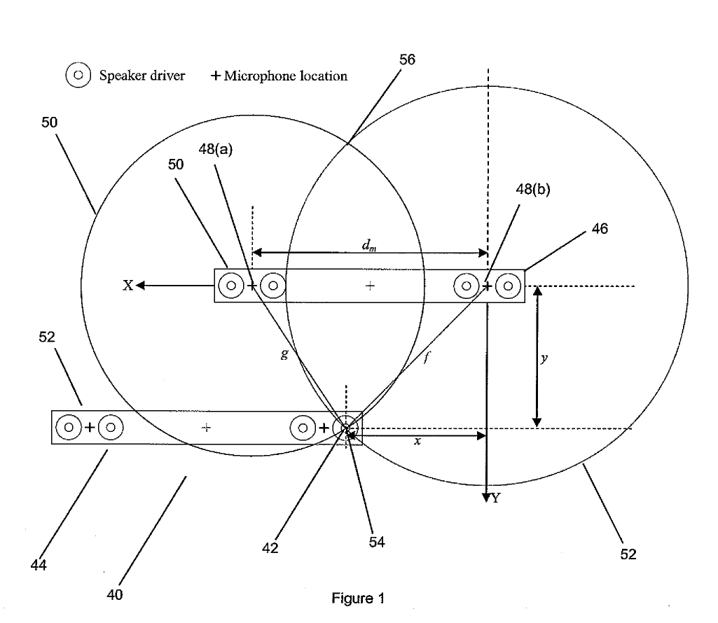

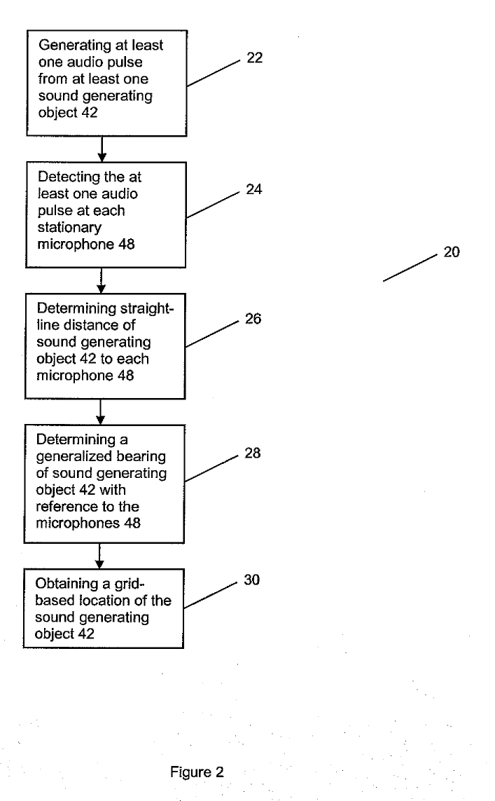

In a first aspect of the present invention as illustrated in FIGS. 1 and 2, there is provided a method for locating a position of at least one sound generating object using at least one audio pulse 20. The at least one audio pulse may be in a form of a logarithmic swept sine (LSS) signal. The use of the LSS is advantageous as it can be detectable at both low volumes and amidst background noises. It should be appreciated that the method for locating a position of at least one sound generating object using at least one audio pulse 20 may be an intermediate process when carrying out audio output tuning (for optimal audio output) for a user who is using a multi-speaker set-up.

FIG. 1 shows a possible set-up 40 for locating a position of at least one sound generating object 42 using the method 20. The method 20 may be enabled by a data processing apparatus which controls all aspects of the method 20. It should be appreciated that an order of the method 20 as described may be varied without deviating from the intended invention. The at least one audio pulse may be any audible audio signal. The at least one sound generating object 42 may be either a single speaker driver or a standalone speaker comprising at least one speaker driver. In FIG. 1, more than one sound generating object 42 is shown. Both a first apparatus 44 and a second apparatus 46 may represent multi-speaker driver soundbars. The first apparatus 44 and the second apparatus 46 may be identical. However, it should be appreciated that the method 20 is not limited to use with soundbars and that the method 20 may be used with any multi-speaker system. A physical configuration of speaker drivers in each standalone speaker of any multi-speaker system is not important in relation to the method 20.

The at least one audio pulse may be detected by a plurality of stationary microphones 48(a), 48(b) located at a first position 50. The plurality of stationary microphones 48(a), 48(b) may each be an omni-directional microphone. Referring to FIG. 1, the first position 50 may be a position of the second apparatus 46. The plurality of stationary microphones 48(a), 48(b) may be incorporated in a single apparatus. FIG. 1 shows the stationary microphones 48(a), 48(b) being incorporated in the second apparatus 46. The stationary microphones 48(a), 48(b) may be effectively deployed in the second apparatus 46 even if the stationary microphones 48(a), 48(b) are not overtly visible on the second apparatus 46. It is advantageous for the stationary microphones 48(a), 48(b) to be incorporated in the second apparatus 46 as this overcomes an inconvenience of using a separate set of microphones to detect the at least one audio pulse. Furthermore, fixedly incorporating the stationary microphones 48(a), 48(b) in the second apparatus 46 allows a position of each of the stationary microphones 48(a), 48(b) to be fixed and not variable. The fixed positions of the stationary microphones 48(a), 48(b) enables the method 20 to be carried out more efficiently without a need for additional procedures to set-up and locate the stationary microphones 48(a), 48(b).

The plurality of stationary microphones 48(a), 48(b) may be spaced apart by a pre-determined distance of at least ten centimetres. The pre-determined distance of at least ten centimetres is required so that the stationary microphones 48(a), 48(b) are able to distinguished and not considered a single microphone. Referring to FIG. 1, the pre-determined distance is represented by “dₘ”. It should be appreciated that a value of “dₘ” is readily available when the stationary microphones 48(a), 48(b) are fixedly incorporated in the second apparatus 46.

FIG. 2 shows a process flow of the method 20. The method 20 includes generating the at least one audio pulse from the at least one sound generating object 42 (22) located at a second position 52. Referring to FIG. 1, the second position 52 may be a position of the first apparatus 44. It should be appreciated that the first position 50 and the second position 52 should not be substantially identical as such an instance would render the method 20 to be redundant as there's no necessity to locate the at least one sound generating object 42 if it is located at the second position 52. It is preferable that the at least one sound generating object 42 generates the at least one audio pulse substantially towards the second apparatus 46.

The method 20 may also include detecting the at least one audio pulse at each of the plurality of stationary microphones (24) 48(a), 48(b). Subsequently, the method 20 includes determining a straight-line distance from the at least one sound generating object 42 to each of the plurality of stationary microphones (26) 48(a), 48(b). The straight-line distance from the at least one sound generating object 42 to each of the plurality of stationary microphones 48(a), 48(b) is determined by multiplying the speed of sound (340 m/s) with a time difference between an audio pulse reception time at each of the plurality of stationary microphones 48(a), 48(b) and an audio pulse transmission time from the at least one sound generating object 42. The audio pulse reception time and the audio pulse transmission time may both be recorded by the data processing apparatus which controls all aspects of the method 20. The data processing apparatus may have a timing system which may be capable of measuring time to a precision of milli-seconds and is capable of recording the audio pulse reception and transmission times. Referring to FIG. 1, the straight-line distance to the stationary microphones 48(a), 48(b) is denoted as “g” and “f” respectively.

Next, the method 20 includes determining a generalised bearing of the at least one sound generating object 42 in relation to each of the plurality of stationary microphones (28) 48(a), 48(b). The generalised bearing essentially provides an approximation of a direction of the at least one sound generating object 42 with reference to the plurality of stationary microphones 48(a), 48(b).

Finally, the method 20 includes obtaining a grid-based location of the at least one sound generating object 42 (30). The grid-based location may be based on a set of arbitrary reference axes. The arbitrary axes shown for illustrative purposes in FIG. 1 is centred at one of the plurality of stationary microphones 48(b). Thus, in this instance, the microphone 48(b) is at a location with coordinates (0,0). The grid-based location may be in a form of coordinates referencing the arbitrary reference axes. It should be appreciated that the grid-based location provides for a location in a two dimensional form. The location in a two dimensional form is sufficient to provide an indication of the position of the at least one sound generating object 42 in a top-down view of any particular room.

The grid-based location of the at least one sound generating object 42 is obtained by determining a first intersection position 54 of a plurality of arcs 50, 52, each of the plurality of arcs 50, 52 being centred at each of the plurality of stationary microphones 48(a), 48(b) respectively. The radii of each of the plurality of arcs 50, 52 are respective straight-line distances from each of the plurality of stationary microphones 48(a), 48(b) to the at least one sound generating object 42. Thus, with reference to FIG. 1, first arc 50 has a radius of “g” while second arc 52 has a radius of “f”. FIG. 1 also shows a second intersection position 56 of the plurality of arcs 50, 52. However, the second intersection position 56 is disregarded in view of the aforementioned generalised bearing of the at least one sound generating object 42 with reference to the plurality of stationary microphones 48(a), 48(b).

It should be appreciated that the grid-based location of the at least one sound generating object 42 may be obtained using mathematical formulae in relation to intersection points of circles. Referring to FIG. 1, the first arc 50 may be mathematically expressed as “(dₘ−x)²+y²=g²” while the second arc 52 may be mathematically expressed as “x²+y²=f²”. The following portion will illustrate how the intersection points are obtained.

(dₘ−x)²+y²=g² (1)

x²+y²=f² (2)

x²−(dₘ−x)²=f²−g²

x²−(dₘ²−2dₘx+x²)=f²−g²

x²−dₘ²+2dₘx−x²=f²−g²

2dₘx=f²−g²+dₘ²

x=(f²−g²+dₘ²)/2dₘ (2)-(1)

Correspondingly, equation (2) leads to:

y²=f²−x²

y=±(f²−x²)

It is evident that the grid-based location (x and y coordinates) of the at least one sound generating object 42 may be consequently obtained when values of f, g and dₘ are known. It should be appreciated that the generalised bearing of the at least one sound generating object 42 in relation to each of the plurality of stationary microphones 48(a), 48(b) primarily determines whether the value of y takes either a positive or a negative value.

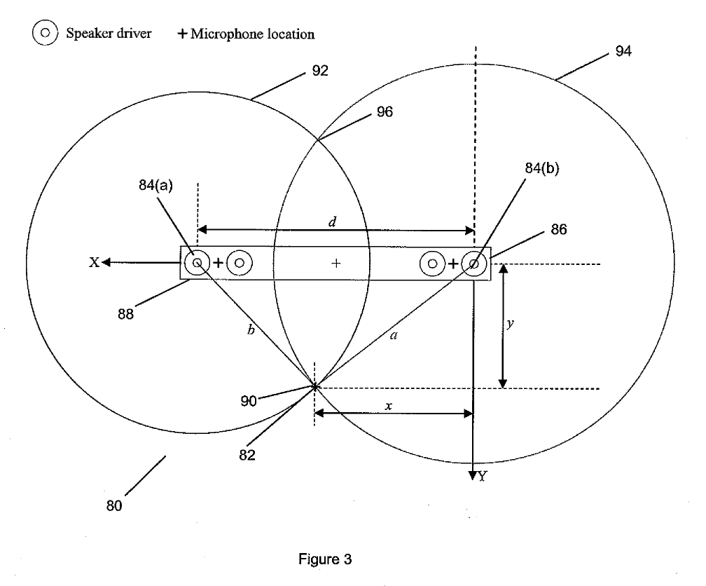

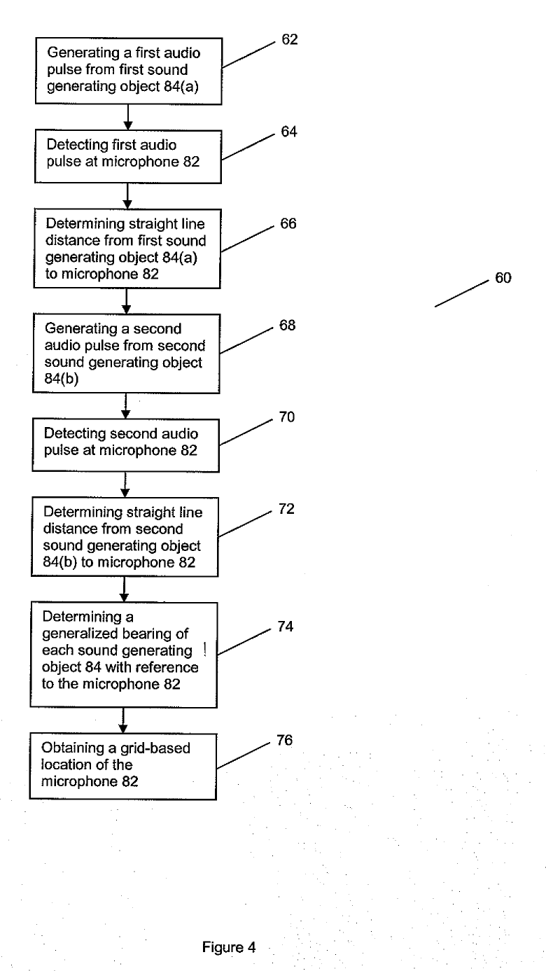

In a second aspect of the present invention as illustrated in FIGS. 3 and 4, there is provided a method for locating a position of a microphone using audio pulses emitted from a plurality of sound generating objects 60. The audio pulses may be in a form of a logarithmic swept sine (LSS) signal. The use of the LSS is advantageous as it can be detectable at both low volumes and amidst background noises. It should be appreciated that the method for locating a position of a microphone using audio pulses from a plurality of sound generating objects 60 may be an intermediate process when carrying out audio output tuning (for optimal audio output) for a user who is using a multi-speaker set-up.

FIG. 3 shows a possible set-up 80 for locating a position of a microphone 82 using the method 60. The microphone 82 may be an omni-directional microphone. The method 60 may be enabled by a data processing apparatus which controls all aspects of the method 60. It should be appreciated that an order of the method 60 as described may be varied without deviating from the intended invention.

The microphone 82 may be coupled to a portable handheld device. The portable handheld device may include, for instance, a mobile phone, a remote control, a portable media player, and so forth. The microphone 82 may be effectively deployed in the portable handheld device even if the microphone is not overtly visible on the portable handheld device. It is advantageous for the microphone to be incorporated in the portable handheld device as this overcomes an inconvenience of using a separate microphone to detect the at least one audio pulse. As such, locating the position of the microphone 82 correspondingly also leads to locating the portable handheld device and accordingly, a location of a user grasping onto the portable handheld device.

The audio pulses may be any audible audio signal. A plurality of sound generating objects 84(a), 84(b) may be spaced apart by a pre-determined distance of at least ten centimetres. The pre-determined distance of at least ten centimetres is required so that the sound generating objects 84(a), 84(b) are able to distinguished and not considered a single sound generating object. Referring to FIG. 3, the pre-determined distance is represented by “d”. Each of the plurality of sound generating objects 84(a), 84(b) may be either a single speaker driver or a standalone speaker comprising at least one speaker driver. In FIG. 3, more than one sound generating object 84 is shown. A third apparatus 86 may represent a multi-speaker driver soundbar. However, it should be appreciated that the method 60 is not limited to use with soundbars and that the method 60 may be used with any multi-speaker system. A configuration of speaker drivers in each standalone speaker of any multi-speaker system is not important in relation to the method 60.

The plurality of sound generating objects 84(a), 84(b) may be located at a third position 88. Referring to FIG. 3, the third position 88 may be a position of the third apparatus 86. It should be appreciated that the position of the microphone 82 should not be substantially identical to the third position 88 as such an instance would render the method 60 to be redundant as there's no necessity to locate the microphone 82 located at the third position 82. It is preferable that the plurality of sound generating objects 84(a), 84(b) generates the audio pulses substantially towards the microphone 82.

FIG. 3 shows a process flow of the method 60. The method 60 includes generating a first audio pulse from a first sound generating object 84(a) of the plurality of sound generating objects (62). The first audio pulse is then detected at the microphone 82 (64). Subsequently, the method 60 includes determining a straight-line distance from the first sound generating object 84(a) to the microphone 82 (66). The straight-line distance from the first sound generating object 84(a) to the microphone 82 is determined by multiplying the speed of sound (340 m/s) with a time difference between an audio pulse reception time at the microphones 82 and an audio pulse transmission time from the first sound generating object 84(a). The audio pulse reception time and the audio pulse transmission time may both be recorded by the data processing apparatus which controls all aspects of the method 60. The data processing apparatus may have a timing system which may be capable of measuring time to a precision of milli-seconds and is capable of recording the audio pulse reception and transmission times. Referring to FIG. 3, the straight-line distance from the first sound generating object 84(a) and the microphone 82 is denoted as “b”.

The method 60 also includes generating a second audio pulse from the second sound generating object 84(b) of the plurality of sound generating objects (68). The second audio pulse is then detected at the microphone 82 (70). Subsequently, the method 60 includes determining a straight-line distance from the second sound generating object 84(b) to the microphone 82 (72). The straight-line distance from the second sound generating object 84(b) to the microphone 82 is determined by multiplying the speed of sound (340 m/s) with a time difference between an audio pulse reception time at the microphones 82 and an audio pulse transmission time from the second sound generating object 84(b). The audio pulse reception time and the audio pulse transmission time may both be recorded by the data processing apparatus which controls all aspects of the method 60. The data processing apparatus may have a timing system which may be capable of measuring time to a precision of milli-seconds and is capable of recording the audio pulse reception and transmission times. Referring to FIG. 3, the straight-line distance from the second sound generating object 84(b) and the microphone 82 is denoted as “a”.

Next, the method 60 includes determining a generalised bearing of each of the plurality of sound generating objects 84 in relation to the microphone 82 (74). The generalised bearing essentially provides an approximation of a direction of the plurality of sound generating objects 84 with reference to the microphone 82.

Finally, the method 60 includes obtaining a grid-based location of the microphone 82 (76). The grid-based location may be based on a set of arbitrary reference axes. The arbitrary axes shown for illustrative purposes in FIG. 3 is centred at the second sound generating object 84(b). Thus, in this instance, the second sound generating object 84(b) is at a location with coordinates (0,0). The grid-based location may be in a form of coordinates referencing the arbitrary reference axes. It should be appreciated that the grid-based location provides for a location in a two dimensional form. The location in a two dimensional form is sufficient to provide an indication of the position of the microphone 82 in a top-down view of any particular room.

The grid-based location of the microphone 82 is obtained by determining a third intersection position 90 of a plurality of arcs, each of the plurality of arcs 92, 94, each of the plurality of arcs 92, 94 being centred at each of the plurality of sound generating objects 84(a), 84(b) respectively. The radii of each of the plurality of arcs 92, 94 are respective straight-line distance from each of the plurality of sound generating objects 84(a), 84(b) to the microphone 82. Thus, with reference to FIG. 3, third arc 92 has a radius of “b” while fourth arc 94 has a radius of “a”. FIG. 3 also shows a fourth intersection position 96 of the plurality of arcs 92, 94. However, the fourth intersection position 96 is disregarded in view of the aforementioned generalised bearing of the plurality of sound generating objects 84 with reference to the microphones 82.

It should be appreciated that the grid-based location of the microphone 82 may be obtained using mathematical formulae in relation to intersection points of circles. Referring to FIG. 3, the third arc 92 may be mathematically expressed as “(d−x)²+y²=b²” while the fourth arc 94 may be mathematically expressed as “x²+y²=a²”. The following portion will illustrate how the intersection points are obtained.

(d−x)²+y²=b² (1)

x²+y²=a² (2)

x²−(d−x)²=a²−b²

x²−(d²−2dx+x²)=a²−b²

x²−d²+2dx−x²=a²−b²

2dx=a²−b²+d²

x=(a²−b²+d²)/2d (2)-(1)

Correspondingly, equation (2) leads to:

y²=a²−x²

y=±(a²−x²)

It is evident that the grid-based location (x and y coordinates) of the microphone 82 may be consequently obtained when values of a, b and d are known. It should be appreciated that the generalised bearing of the plurality of sound generating objects 84 in relation to the microphone 82 primarily determines whether the value of y takes either a positive or a negative value.

Based on the description in the preceding paragraphs, the present invention advantageously enables sound generating objects and microphones to be located in a multi-speaker set-up. In relation to locating sound generating objects, the present invention is advantageous as determining positions of the sound generating objects in the multi-speaker set-up is an essential aspect in relation to tuning audio output from the multi-speaker set-up. Each of the sound generating objects may include a digital signal processor for decoding an appropriate audio stream associated with a physical location of the sound generating object. Alternatively, if each of the sound generating objects do not include a digital signal processor, there may be a central digital signal processor for decoding all usable audio streams for transmission to the sound generating objects in accordance to a physical location of the sound generating object.

In relation to locating microphones which may be coupled to a portable handheld device, the present invention is advantageous as determining a position of the user grasping the portable handheld device is also an essential aspect in relation to tuning audio output from the multi-speaker set-up.

Whilst there has been described in the foregoing description preferred embodiments of the present invention, it will be understood by those skilled in the technology concerned that many variations or modifications in details of design or construction may be made without departing from the present invention.

1. A method for locating a position of at least one sound generating object using at least one audio pulse, the at least one audio pulse being detected by a plurality of stationary microphones located at a first position being spaced apart by a pre-determined distance, the method including:
generating the at least one audio pulse from the at least one sound generating object located at a second position;
detecting the at least one audio pulse at each of the plurality of stationary microphones;
determining a straight-line distance from the at least one sound generating object to each of the plurality of stationary microphones;
determining a generalised bearing of the at least one sound generating object in relation to each of the plurality of stationary microphones; and
obtaining a grid-based location of the at least one sound generating object,
wherein the grid-based location is obtained by determining a first intersection position of a plurality of arcs, each of the plurality of arcs being centred at each of the plurality of stationary microphones, with respective radii of each of the plurality of arcs being a respective straight-line distance from each of the plurality of stationary microphones to the at least one sound generating object.

2. The method of claim 1, wherein the straight-line distance from the at least one sound generating object to each of the plurality of stationary microphones is determined by multiplying the speed of sound with a time difference between an audio pulse reception time at each of the plurality of stationary microphones and an audio pulse transmission time from the at least one sound generating object.

3. The method of claim 1, wherein the generalised bearing provides an approximation of a direction of the at least one sound generating object with reference to the plurality of stationary microphones.

4. The method of claim 1, wherein the plurality of stationary microphones is incorporated in a single apparatus.

5. The method of claim 4, wherein incorporating the plurality of stationary microphones in a single apparatus overcomes a need to use a separate set of microphones.

6. The method of claim 1, wherein the grid-based location is based on a set of arbitrary reference axes.

7. The method of claim 6, wherein the grid-based location is in a form of coordinates referencing the arbitrary reference axes.

8. The method of claim 1, wherein a second intersection position of the plurality of arcs is disregarded in view of the generalised bearing of the at least one sound generating object.

9. The method of claim 1, wherein the sound generating object is either a single speaker driver or a standalone speaker.

10. The method of claim 1, wherein the pre-determined distance is at least ten centimetres so that the stationary microphones are able to distinguished and not considered a single microphone.

11. The method of claim 1 being carried out by a data processing apparatus.

12. The method of claim 1, wherein the at least one audio pulse is in a form of a logarithmic swept sine (LSS) signal, the LSS signal being detectable at both low volumes and amidst background noises.

13. A method for locating a position of a microphone using audio pulses emitted from a plurality of sound generating objects, the plurality of sound generating objects being spaced apart by a pre-determined distance, the plurality of sound generating objects being located at a third position, the method including:
generating a first audio pulse from a first sound generating object of the plurality of sound generating objects;
detecting the first audio pulse at the microphone;
determining a straight-line distance from the first sound generating object to the microphone;
generating a second audio pulse from a second sound generating object of the plurality of sound generating objects;
detecting the second audio pulse at the microphone;
determining a straight-line distance from the second sound generating object to the microphone;
determining a generalised bearing of each of the plurality of sound generating objects in relation to the microphone; and
obtaining a grid-based location of the microphone,
wherein the grid-based location is obtained by determining a third intersection position of a plurality of arcs, each of the plurality of arcs being centred at each of the plurality of sound generating objects, with respective radii of each of the plurality of arcs being a respective straight-line distance from each of the plurality of sound generating objects to the microphone.

14. The method of claim 13, wherein the microphone is coupled to a portable handheld device.

15. The method of claim 14, wherein coupling the microphone to the portable handheld device overcomes a need to use a separate microphone.

16. The method of claim 13, wherein the straight-line distance from the plurality of sound generating objects to the microphone is determined by multiplying the speed of sound with a time difference between an audio pulse reception time at the microphone and an audio pulse transmission time from each of the plurality of sound generating objects.

17. The method of claim 13, wherein the generalised bearing provides an approximation of a direction of the plurality of sound generating objects with reference to the microphone.

18. The method of claim 13, wherein the grid-based location is based on a set of arbitrary reference axes.

19. The method of claim 18, wherein the grid-based location is in a form of coordinates referencing the arbitrary reference axes.

20. The method of claim 13, wherein a fourth intersection position of the plurality of arcs is disregarded in view of the generalised bearing of the plurality of sound generating objects.

21. The method of claim 13, wherein the plurality of sound generating objects is incorporated in a single apparatus.

22. The method of claim 13, wherein the sound generating object is either a single speaker driver or a standalone speaker.

23. The method of claim 13, wherein the pre-determined distance is at least ten centimetres so that the sound generating objects are able to distinguished and not considered a single sound generating object.

24. The method of claim 13 being carried out by a data processing apparatus.

25. The method of claim 13, wherein the audio pulses is in a form of a logarithmic swept sine (LSS) signal, the LSS signal being detectable at both low volumes and amidst background noises.
